(19) United States
(12) Patent Application Publication
(10) Pub. No.: US 2016/0307466 A1
(43) Pub. Date: Oct. 20, 2016

(54) METHOD AND SYSTEM FOR PROVIDING FINANCIAL EDUCATION BASED ON TRANSACTION DATA

(71) Applicant: MASTERCARD INTERNATIONAL INCORPORATED, Purchase, NY (US)

(72) Inventors: John GIOACCHINI, Yorktown Heights, NY (US); Shekhar SAHGAL, Stamford, CT (US)

(73) Assignee: MASTERCARD INTERNATIONAL INCORPORATED, Purchase, NY (US)

(21) Appl. No.: 14/690,969

(22) Filed: Apr. 20, 2015

(51) Int. Cl. G09B 19/18

(52) U.S. Cl. CPC G09B 19/18

(57) ABSTRACT

A method for providing financial education services to a consumer includes: storing account profiles, each profile including data related to a transaction account including an account identifier and contact information; storing transaction rules, each rule being associated with a financial education opportunity and including application criteria and required actions; receiving a copy of a transaction message used in an associated payment transaction that includes a specific account identifier and data fields; identifying a specific account profile where the included account identifier corresponds to the specific account identifier; identifying an application transaction rule based on a correspondence between the application criteria and data included in data fields included in the transaction message; performing the required actions included in the identified transaction rule including transmitting financial education data to a consumer associated with the specific account profile using the included contact information.

### FIELD

The present disclosure relates to the providing of financial education services to consumers, specifically the identification of educational services and opportunities in real-time or near real-time to consumers based on authorization requests and other transaction messages for payment transactions involving a consumer.

### BACKGROUND

The financial education level of consumers can vary, with some consumers having a sophisticated knowledge of every aspect of finances, payment cards, and various types of transaction accounts, and others having very little knowledge as to how the payment instruments they use work in practice. While consumer with less sophisticated knowledge may benefit greatly from financial education, there can often be instances where even the most knowledgeable consumers can benefit from additional education and/or information regarding financial services and opportunities.

However, there is currently a lack of suitable methods for educating consumers regarding finance. In some systems, consumers can subscribe to a newsletter or subscription and receive helpful tips, such as on a daily basis. However, these tips are often agnostic as to the situation, education, and experiences of the individual consumer. In particular, the tips are provided to the consumer on a periodic basis and without regard to any transactions being conducted by the consumer. In other systems, such as those operating in conjunction with budgeting tools, transactions conducted involving a consumer are mined to identify instances where third party services may be offered to the consumer. For example, if a consumer has a credit card and pays a finance charge, the system may identify an alternative credit card with a lower interest rate for offering to the consumer to receive a commission.

However, these systems often suffer from a number of disadvantages. Often times, in order to receive transaction data, consumers must provide the service with sensitive login information to financial institution accounts held by the consumer. Some consumers may be unwilling to share such information. In addition, retrieving the transaction data relies on the system's ability to connect to the institution and retrieve the data, which can often take a significant amount of time. As a result, any attempted educational opportunities are thus often identified days after a transaction actually takes place, which may have a weaker effect on the consumer. In addition, these systems often operate by providing referrals to third party services to the consumer for commission rather than actual financial education to the consumer. Thus, not only does the data the system use lag behind and is thereby ineffective, the information that is eventually provided is also often lacking in educational value.

Thus, there is a need for a technical system where transaction information can be received and analyzed in real-time or near real-time, without requiring consumers to surrender sensitive account information. Because existing systems operate using application programming interfaces (APIs) and other tools for retrieving transaction information from financial institution websites, existing systems are not equipped to receive or read transaction messages, which require special communication protocols and data analysis. In addition, because these systems may operate using referrals, they are not configured to identify educational opportunities and services based on individual transaction data. As a result, there is a need for a technical solution that can improve on existing systems using technological advancements discussed herein.

### SUMMARY

The present disclosure provides a description of systems and methods for providing financial education services to consumers.

A method for providing financial education services to a consumer includes: storing, in an account database, a plurality of account profiles, wherein each account profile includes data related to a transaction account including at least an account identifier and contact information; storing, in a rules database, one or more transaction rules, wherein each transaction rule is associated with a financial education opportunity and includes one or more application criteria and at least one required action; receiving, by a receiving device, a transaction message associated with a payment transaction, wherein the transaction message is a copy of a transaction message used in the associated payment transaction and includes at least a specific account identifier and one or more data fields; identifying, by a processing device, a specific account profile stored in the account database where the included account identifier corresponds to the specific account identifier included in the received transaction message; identifying, by the processing device, an application transaction rule stored in the rules database based on a correspondence between the included one or more application criteria and data included in the one or more data fields included in the received transaction message; performing, by the processing device, the at least one required action included in the identified application transaction rule, wherein the at least one required action includes transmitting, by a transmitting device, financial education data to a consumer associated with the specific account profile using the included contact information.

A system for providing financial education services to a consumer includes a transmitting device, an account database, a rules database, a receiving device, and a processing device. The account database is configured to store a plurality of account profiles, wherein each account profile includes data related to a transaction account including at least an account identifier and contact information. The rules database is configured to store one or more transaction rules, wherein each transaction rule is associated with a financial education opportunity and includes one or more application criteria and at least one required action. The receiving device is configured to receive a transaction message associated with a payment transaction, wherein the transaction message is a copy of a transaction message used in the associated payment transaction and includes at least a specific account identifier and one or more data fields. The processing device is configured to: identify a specific account profile stored in the account database where the included account identifier corresponds to the specific account identifier included in the received transaction message; identify an application transaction rule stored in the rules database based on a correspondence between the included one or more application criteria and data included in the one or more data fields included in the received transaction message; and perform the at least one required action included in the identified application transaction rule. The at least one required action includes transmitting, by the transmitting device, financial education data to a consumer associated with the specific account profile using the included contact information.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for providing financial education services to consumers in accordance with exemplary embodiments.

FIG. 2 is a block diagram illustrating the mobile device of FIG. 1 for providing financial education services to consumers in accordance with exemplary embodiments.

FIG. 3 is a flow diagram illustrating a process for providing financial education services to consumers using the processing server of FIG. 2 in accordance with exemplary embodiments.

FIGS. 4A-4D are diagrams illustrating graphical user interfaces of a consumer device for receiving financial education information in real-time or near real-time based on conducted transactions in accordance with exemplary embodiments.

FIG. 5 is a flow chart illustrating an exemplary method for providing financial education services to a consumer in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

### System for Providing Financial Education Services

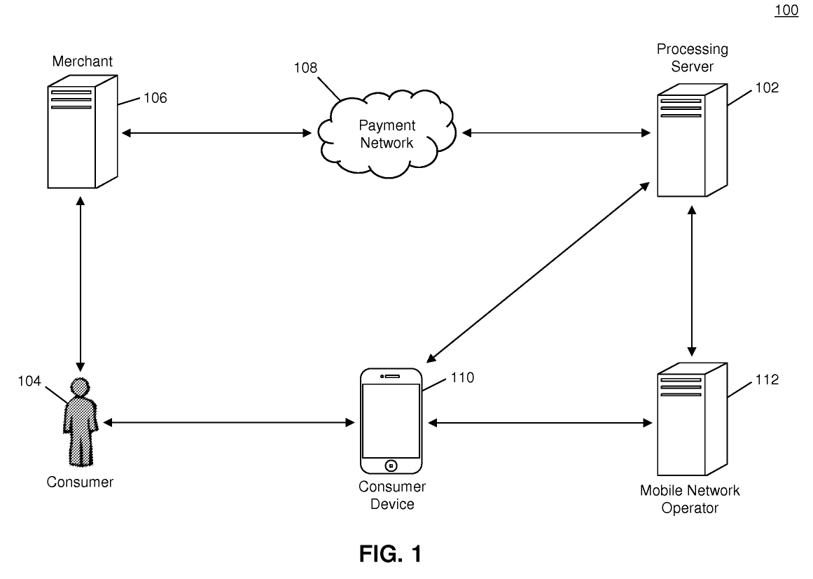

FIG. 1 illustrates a system 100 for the providing of financial education services to a consumer in real-time or near real-time based on a conducted payment transaction.

The system 100 may include a processing server 102. The processing server 102, discussed in more detail below, may be configured to identify financial education opportunities for a consumer 104 in real-time or near real-time based on payment transactions conducted involving the consumer 104. The consumer 104 may interact with a merchant 106 to initiate a payment transaction and use a payment instrument, such as a credit card, debit card, merchant card, pre-paid card, substitute card, or nearly any other transaction enabling account, virtual or physical, associated with or being a transaction account for funding the payment transaction. The merchant 106 or a financial institution acting on behalf of the merchant 106, such as an acquiring bank, may submit an authorization request for the payment transaction to a payment network 108. The payment network 108 may process the payment transaction using traditional methods and systems that will be apparent to persons having skill in the relevant art.

The authorization request submitted to the payment network 108 may be a transaction message that is formatted pursuant to one or more standards that govern the interchange of transaction messages, such as the International Organization for Standardization's ISO 8583. Pursuant to the one or more standards, the authorization request may include a plurality of data fields, each configured to store predetermined information associated with the payment transaction, the involved merchant 106, the involved consumer 104, and/or the transaction account used by the consumer 104 to fund the payment transaction. For example, the authorization request may include a data field configured to store a primary account number, which may include an account number associated with the transaction account used to fund the corresponding payment transaction.

The payment network 108 may transmit a copy of the authorization request or other transaction message involved in the processing of the payment transaction, such as the authorization response, a clearing record, etc., to the processing server 102. The processing server 102 may then identify one or more financial educational opportunities based on the data included therein, using the methods and systems discussed herein. The processing server 102 may identify one or more transaction rules that can be applied to the payment transaction, such as based on criteria included in the data fields included in the transaction message. The transaction rules may be applied, and corresponding actions performed by the processing server 102. The corresponding actions may include at least the transmitting of financial education data to the consumer 104 in real-time or near real-time by the processing server 102.

Financial education data may be transmitted to the consumer 104 via a consumer device 110 associated with the consumer 104. The consumer device 110 may be a cellular phone, smart phone, tablet computer, notebook computer, laptop computer, desktop computer, smart television, smart watch, wearable computing device, etc. configured to receive data. The financial education data may be transmitted to the consumer device 110 in any format suitable for receipt and reading using the consumer device 110, such as an e-mail message, short message service (SMS) message, multimedia message service (MMS) message, application program notification, etc. The data may be transmitted to the consumer device 110 directly, or via a third party, such as a mobile network operator 112. The mobile network operator 112, for example, may be an operator of a communication network associated with the consumer device 110 and may transmit the financial education data to the consumer device 110 using the communication network.

In some embodiments, the consumer 104 may opt-in to a service in order to receive the financial education messages. During the opt-in process, the consumer 104 may provide contact information for providing the financial education messages to the processing server 102, such as via a web page, application program, etc. The contact information may include information suitable for use by the processing server 102 to transmit messages to the consumer device 110, such as an e-mail address, phone number, media access control address, internet protocol address, etc. The processing server 102 may store the information for use in transmitting the financial education messages at the appropriate times.

The consumer 104 may then view the financial education data using their consumer device 110. Because the processing server 102 is specially configured to receive and read transaction messages, the processing server 102 may be able to more quickly and efficiently identify financial education opportunities for the consumer 104, such as in real-time or near real-time. In addition, by receiving the transaction messages themselves, the processing server 102 may have more information available suitable for use in identifying financial education opportunities than other systems, as the transaction data in other systems may not include each of the data fields included in the transaction message. Furthermore, the processing server 102 may obtain the transaction data without the need to use sensitive login information provided by the consumer 104, which may enhance the consumer experience and maintain a higher level of consumer privacy.

In some embodiments, the processing server 102 may be configured to store transaction messages and/or the transaction data included therein for a consumer 104. In such an embodiment, the processing server 102 may use the stored transaction data in the identification of financial education opportunities and/or the financial education data transmitted thereby to the consumer 104. For example, the processing server 102 may, when a transaction is conducted and the transaction message provided to the processing server 102, identify a financial education opportunity based on historical transaction data of the consumer 104, such as identifying a spending pattern for the consumer 104 and how the consumer 104 may be provided positive financial education. For instance, if the processing server 102 may identify recurring payments by the consumer 104 and provide information about consolidating debts and refinancing.

In some instances, financial educational opportunities identified by the processing server 102 may include financial services. For example, if the consumer 104 makes a mortgage payment for a high interest rate, when the consumer 104 may be refinanced to a lower interest rate, the processing server 102 may identify refinancing services available for dissemination to the consumer 104. Additionally or alternatively, the consumer 104 might be provided with information about the advantages of pre-paying principle or what other ancillary information might be of interest. In some instances, the determination by the processing server 102 may be made based on the transaction message data alone, or may also be based on additional data, such as provided by the consumer 104, the payment network 108, the merchant 106, or a third party, such as a service provider, credit bureau, etc. For instance, the processing server 102 may determine the interest rate for the consumer 104 based on interest rates at the start of the recurring payment received from a third party and current interest rates to determine if refinancing is beneficial, or may receive information directly from the consumer 104 regarding their current interest rate. In another example, if the consumer 104 uses an automated teller machine (ATM) that charges a fee, the processing server 102 may identify nearby ATMs that do not charge a fee or charge a lesser fee, and provide such information to the consumer 104. In such instances, the processing server 102 may not only educate the consumer 104, but may provide the consumer 104 with information regarding additional or alternative financial educational services that may be of benefit to the consumer 104.

### Processing Server

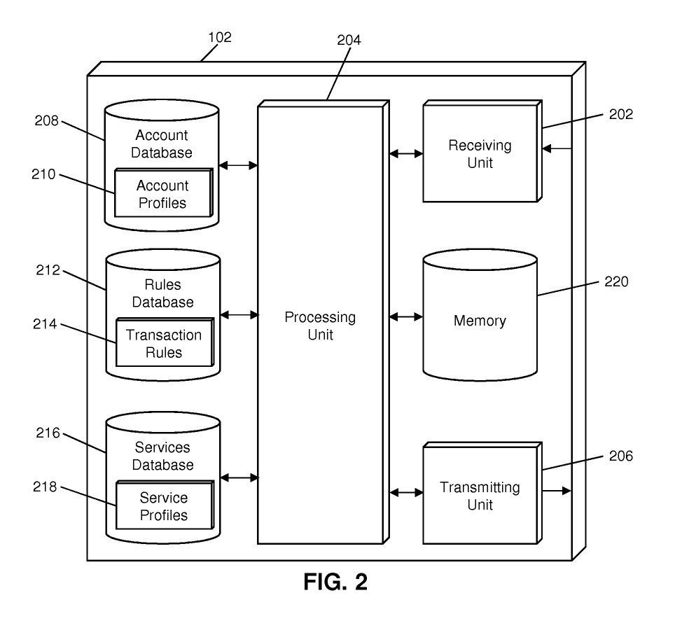

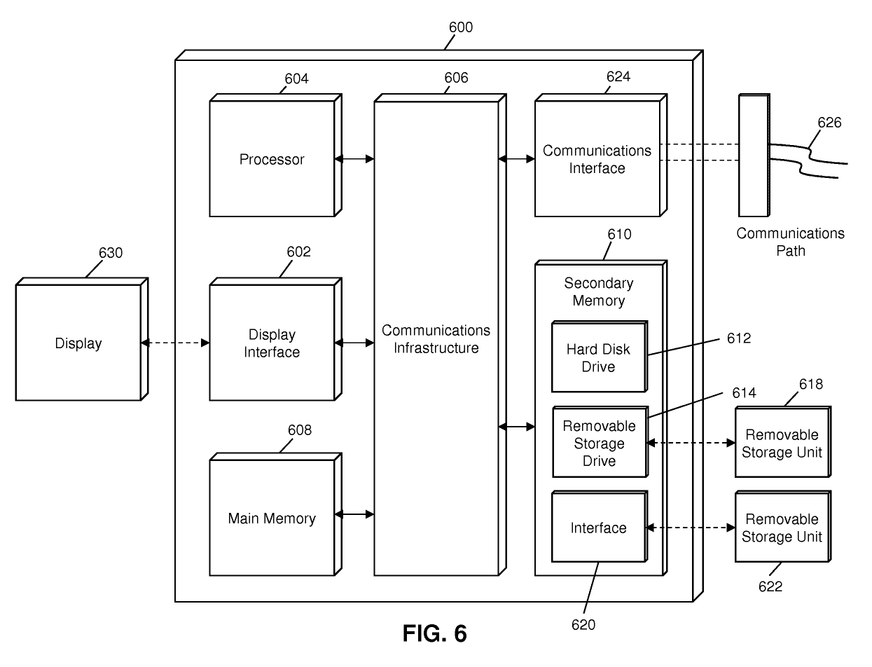

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. For example, the receiving unit 202 may receive transaction messages from the payment network 108 using one or more acceptance communication protocols for the interchange of transaction messages. The receiving unit 202 may also receive data from the consumer 104, such as via the consumer device 110, such as registration information, responses to provided financial education data, etc. For example, the receiving unit 202 may receive requests for additional information from the consumer device 110.

The processing server 102 may also include an account database 208. The account database 208 may be configured to store a plurality of account profiles 210. Each account profile 210 may include data related to one or more transaction accounts including at least an account identifier and contact information. The account identifier may be a unique value suitable for identification of the account profile 210 or a related transaction account, such as a username, phone number, e-mail address, transaction account number, etc. In some instances, an account profile 210 may include an account identifier for each of a plurality of related transaction accounts, such as in instances where a consumer 104 may register multiple transaction accounts for use in receiving financial education services.

The contact information may be information suitable for use in providing financial education data to one or more consumers 104 associated with an account profile 210. The contact information may include device identifiers associated with a consumer device 110, such as a media access control address, internet protocol address, or phone number, or may include any alternative contact information, such as an account name, username, e-mail address, etc. In some instances, the contact information and account identifier may be the same value, such as an e-mail address. Additional data suitable for use as contact information will be apparent to persons having skill in the relevant art.

The processing server 102 may also include a rules database 212. The rules database 212 may be configured to store a plurality of transaction rules 214. Each transaction rule 214 may be associated with a financial education opportunity and may include one or more application criteria and at least one required action. The one or more application criteria may be criteria used to determine if the associated financial education opportunity applies to a payment transaction. For example, if the associated financial education opportunity is to inform the consumer 104 of ATMs that do not charge a service fee, the application criteria may include a data field of a transaction message indicating the point of sale as being an ATM. In another example, if the associated financial education opportunity is to inform the consumer 104 of helpful budgeting techniques, the application criteria may include a total transaction amount during a predetermined period of time (e.g., a month) with transactions having data fields including a specific merchant category code.

The processing server 102 may further include a processing unit 204. The processing unit 204 may be configured to perform the functions of the processing server 102 discussed herein as will be apparent to persons having skill in the relevant art. When a transaction message is received, the processing unit 204 may identify an account profile 210 stored in the account database 208 that corresponds to the transaction message, such as using an account identifier included in the transaction message. The processing unit 204 may be configured to identify transaction rules 214 in the transaction database 212 that correspond to the received transaction message. Corresponding transaction rules 214 may be identified based on correspondence between the included application criteria and the data included in data fields in the received transaction message. Once a transaction rule 214 is identified, the one or more required actions may be performed by the processing unit 204. For example, the processing unit 204 may calculate one or more values associated with the financial education opportunity, such as the calculation of potential savings by the consumer 104.

The one or more required actions may also include the transmitting of financial education data (e.g., included in the transaction rule 214 and/or identified by the processing unit 204 as one of the required actions) to the consumer 104. The financial education data may be transmitted to the consumer 104 using the contact information included in the associated account profile 210. The processing server 102 may include a transmitting unit 206, which may be configured to transmit data over one or more networks using one or more network protocols, including the transmitting of the financial education data to the consumer 104 and/or the consumer device 110 using suitable methods. In some embodiments, the transmitting unit 206 may transmit requests for data to one or more third parties, for the receipt of additional data (e.g., by the receiving unit 202). For example, the transmitting unit 206 may transmit a request for pricing information to one or more third parties, which may then be included in the financial education data provided to the consumer 104, such as price comparison information.

In some embodiments, the processing server 102 may also include a services database 216. The services database 216 may be configured to store a plurality of service profiles 216. Each service profile 216 may include data related to a financial education service including at least service data. In such embodiments, the at least one required action included in a transaction rule 214 may include the identification of a service profile 216. The service data may include data to be transmitted to the consumer 104 and included in the financial education data, and/or may include one or more additional actions to be performed by the processing unit 204. For example, if a service profile 218 corresponds to a loan refinancing service, the service data may include information for the calculation of an interest rate by the processing unit 204 and additional data to be provided to the consumer 104 for education regarding the refinancing of a loan. Additional types of financial services and values associated thereby will be apparent to persons having skill in the relevant art.

The processing server 102 may also include a memory 220. The memory 220 may be configured to store data suitable for performing the functions of the processing server 102 discussed herein. For example, the memory 220 may be configured to store data suitable for the communicating and analyzing of transaction messages, rules and/or algorithms for performing calculations and other required actions, data for formatting and transmitting messages to consumers 104 and various consumer devices 110, etc. Additional data that may be stored in the memory 220 will be apparent to persons having skill in the relevant art.

In some embodiments, each account profile 210 may be further configured to store transaction data associated with one or more payment transactions involving the related transaction account(s). The transaction data may include data included in a corresponding transaction message, such as included in the data fields, and/or the transaction message itself. In such embodiments, the processing unit 204 may be configured to identify transaction data included in an account profile 210 for use in performing one or more required actions and/or including in the financial education data transmitted to the consumer 104. For example, the financial education data transmitted to a consumer 104 may include spending trends or habits for a merchant category, which may include the identification of transaction data for payment transactions involving a merchant 106 in the corresponding merchant category in the account profile 210 by the processing unit 204.

In some embodiments, the processing server 102 may include additional components and/or the components included in the processing server 102 as illustrated in FIG. 2 and discussed herein may be configured to perform additional functions. For example, in some embodiments, the processing server 102 may be a part of the payment network 108. In such embodiments, the processing server 102 may include additional components and/or the components of the processing server 102 illustrated in FIG. 2 and discussed herein may be configured to perform additional functions associated with functions of the payment network 108, such as for the processing of payment transactions.

### Process for Providing Financial Education Services

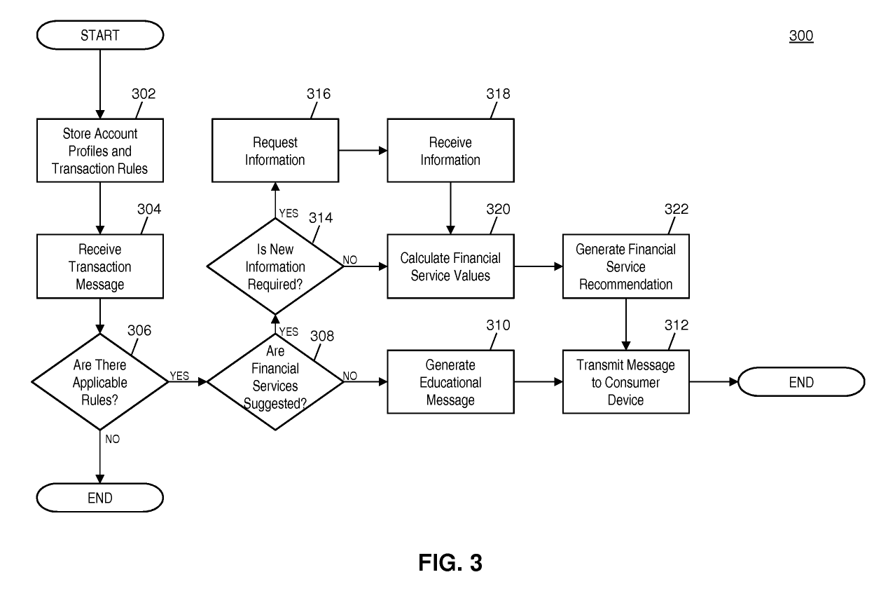

FIG. 3 illustrates a process 300 for providing financial education services to a consumer 104 in real-time or near real-time based on transaction data using the processing server 102.

In step 302, the processing server 102 may store a plurality of account profiles 210 in the account database 208 and a plurality of transaction rules 214 in the rules database 212. Each account profile 210 may include at least an account identifier and contact information. Each transaction rule 214 may include at least one or more application criteria and at least one required action. In step 304, the receiving unit 202 of the processing server 102 may receive a transaction message. The transaction message may be a copy of a transaction message used in the processing of a payment transaction, such as an authorization request, and may be formatted pursuant to one or more standards and include a plurality of data fields.

In step 306, the processing unit 204 of the processing server 102 may determine if there are any transaction rules applicable to the received transaction message. The determination may be based on the identification of any transaction rule 214 where the included one or more application criteria correspond to data included in the plurality of data fields included in the received transaction message. In some instances, the determination may also be based on historical transaction data. In such an instance, the processing unit 204 may first identify an account profile 210 that includes an account identifier included in the transaction message (e.g., in a data field configured to store a personal account number) and may then identify any transaction data included in the account profile 210 as necessary for the determination, such as based on the applicable criteria included in the transaction rule 214. If the processing unit 204 determines that there are no applicable transaction rules 214, then the process 300 may be completed.

If, in step 306, the processing unit 204 determines that a transaction rule 214 does apply to the transaction, then, in step 308, the processing unit 204 may identify the at least one required action included in the transaction rule 214 to determine if any financial services are to be suggested to the consumer 104 involved in the payment transaction. If no financial services are suggested, then, in step 310, the processing unit 204 may generate the educational message. The educational message may include financial education data that may be based on data included in the transaction rule 214 and/or generated performing any of the included actions, such as values calculated by the processing unit 204 or identified thereby. In step 312, the transmitting unit 206 of the processing server 102 may transmit the message to the consumer 104 and/or the consumer device 110 using the contact information included in the account profile 210.

If, in step 308, the processing unit 204 determines that a financial service is to be suggested, then, in step 314, the processing unit 204 may further determine if new information is to be obtained prior to making the suggestion. For example, the transaction rule 214 may indicate a financial service, such as associated with a service profile 218 stored in the services database 216. The processing unit 204 may identify the service profile 218, which may include an action to obtain new information regarding the associated financial service. For instance, if the financial service is a price comparison service, the processing server 102 may be required or recommended to obtain updated price comparison information. If new information is required, then, in step 316, the transmitting unit 206 may transmit a request for the new information. In step 318, the receiving unit 202 may receive the new information.

Once the new information has been obtained, or if no new information was required at step 314, then, in step 320, the processing unit 204 may calculate any values associated with the financial service, such as indicated in the corresponding service data in the service profile 218. Once the values have been calculated, then, in step 322, the processing unit 204 may generate a financial service recommendation. The service recommendation may include any service data or data generated and/or identified thereby. In some instances, the service recommendation may also include financial education data, such as included in the applicable transaction rule 214. Once the recommendation and any associated message have been generated, then the process 300 may proceed to step 312 where the transmitting unit 206 transmits the message to the consumer 104 and/or the consumer device 110.

### Graphical User Interface

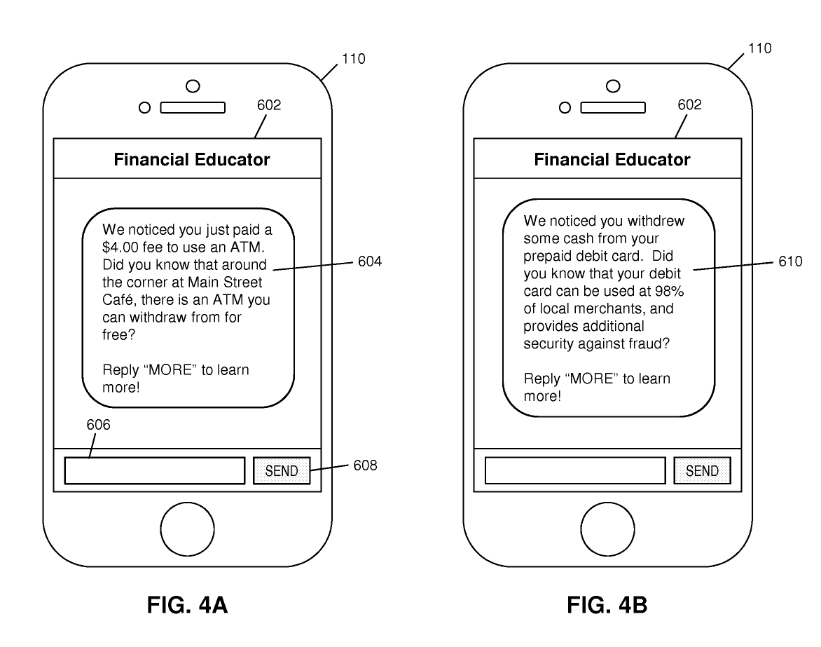

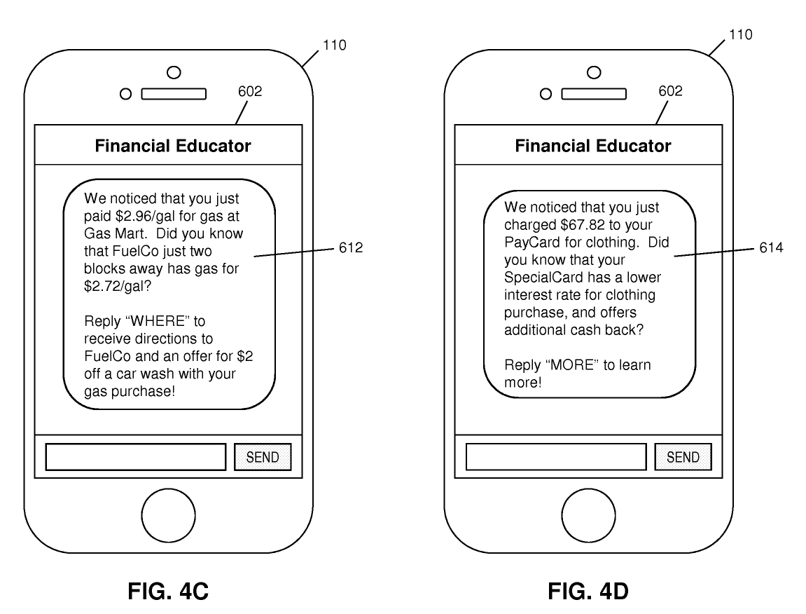

FIGS. 4A-4D illustrate exemplary graphical user interfaces of the consumer device 110 for receiving and displaying financial education messages to the consumer 104, such as those received as a result of the steps performed in the process 300 illustrated in FIG. 3 and discussed above. It will be apparent to persons having skill in the relevant art that the graphical user interfaces illustrated in FIGS. 4A-4D and discussed herein are used for illustrative purposes only, and that additional and/or alternative interfaces or configurations thereof may be used in conjunction with the methods and systems discussed herein.

FIG. 4A illustrates a display 602 of the consumer device 110 for displaying financial education information to the consumer 104. The display 602 may include an education message 604. The education message 604 may include financial education data identified by the processing server 102 as part of the processes discussed herein, such as the process 300 illustrated in FIG. 3 and discussed above. The financial education data may include education information, service data, calculated values, recommendations, geographic information, historical transaction data, trends, news, etc. In FIG. 4A, the education message 604 includes data indicating that the consumer 104 paid a $4.00 service fee for an ATM, and provides information on a different nearby ATM where the consumer 104 can withdraw cash without a fee. The consumer 104 may then have the knowledge to visit the other ATM for future withdrawals to avoid additional service charges.

The display 602 may also include a text field 606 and a submit button 608. The text field 606 and submit button 608 may be part of a messaging application program stored on and executed by the consumer device 110, such as for the sending of SMS messages, e-mail messages, etc. The consumer 104 may enter in a message in the text field 606 to submit to the processing server 102 via the submit button 608 for additional information or to otherwise interact with the processing server 102. For example, in the example illustrated in FIG. 4A, the consumer 104 may send a message consisting of “MORE” to the processing server 102 to learn more about the education message 604, such as a detailed location of the recommended ATM, information regarding ATM service fees, their account policies regarding ATMs and service fees, instructions on how to get to the recommended ATM, etc.

FIG. 4B illustrates an additional education message 610 that may be transmitted to the consumer device 110 using the methods and systems discussed herein. In the education message 610 illustrated in FIG. 4B, the consumer 104 may be informed, upon the withdrawal of cash using a prepaid debit card, that a majority of local merchants accept the prepaid debit card directly for payment and that it can provide additional security against fraud over using cash for purchases. The consumer 104 may then have the knowledge that they can use their prepaid debit card for additional security and to avoid carrying cash and visiting ATMs. The consumer 104 is also invited to request additional information, such as the benefits of using their debit card at merchants, a list of merchants that accept the prepaid debit card for payment, additional features of their prepaid debit card, etc.

FIG. 4C illustrates yet another education message 612 that may be transmitted to the consumer device 110 using the methods and systems discussed herein. In the education message 612 illustrated in FIG. 4C, the consumer 104 may have purchased gas at a gas station and may be informed of an alternative, nearby gas station that has less expensive fuel, such as in conjunction with a price comparison or other type of financial service. The consumer 104 is also invited to send a request to the processing server 102 for directions, and may also receive an offer if the consumer 104 visits the alternative gas station. The information may be identified based on service data included in a service profile 218, such as associated with a price comparison service or the other, nearby gas station. In some embodiments, offers, rewards, coupons, discounts, etc. may be included in messages transmitted to consumers 104, such as in the education message 612 illustrated in FIG. 4C.

FIG. 4D illustrates yet another education message 614 that may be transmitted to the consumer device 110 using the methods and systems discussed herein. In the education message 614 illustrated in FIG. 4D, the consumer 104 may be informed of a competing payment card than one currently being used by the consumer 104, such as based on a finance charge paid by the consumer 104 in a transaction and/or historical transaction data for transactions conducted using that payment card. The consumer 104 may also request additional information, such as about their own card and interest rate, about the competing card, about payment cards and interest rates in general, etc.

### Exemplary Method for Providing Financial Education Services to a Consumer

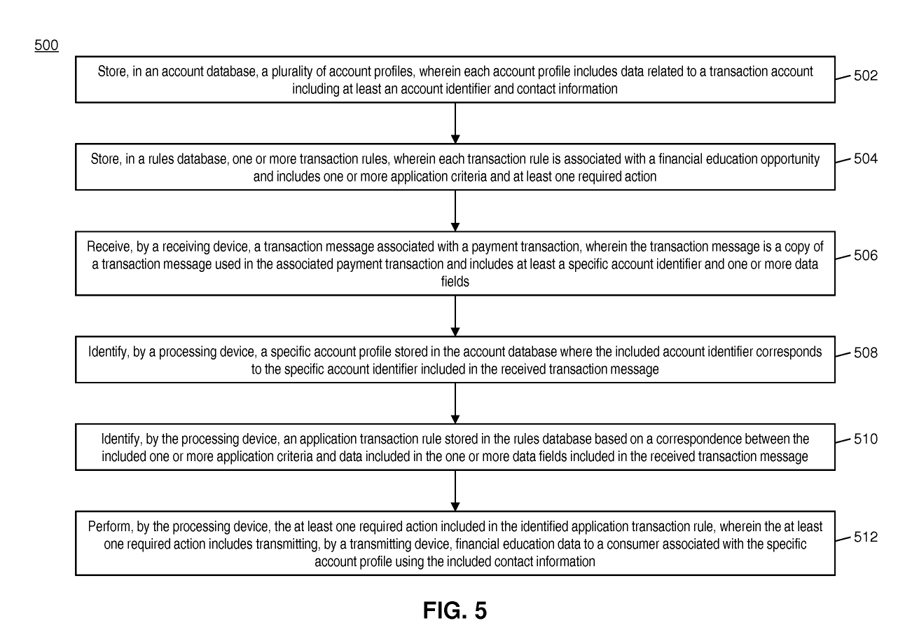

FIG. 5 illustrates a method 500 for providing financial education services to a consumer based on transaction data.

In step 502, a plurality of account profiles (e.g., account profiles 210) may be stored in an account database (e.g., the account database 208), wherein each account profile 210 includes data related to a transaction account including at least an account identifier and contact information. In step 504, one or more transaction rules (e.g., transaction rules 214) may be stored in a rules database (e.g., the rules database 212), wherein each transaction rule 214 is associated with a financial education opportunity and includes one or more application criteria and at least one required action.

In step 506, a transaction message associated with a payment transaction may be received by a receiving device (e.g., the receiving unit 202), wherein the transaction message is a copy of a transaction message used in the associated payment transaction and includes at least a specific account identifier and one or more data fields. In one embodiment, the one or more data fields may include at least one of: a geographic location, a merchant identifier, a transaction amount, a merchant category, product data, offer data, loyalty data, and payment method. In some embodiments, the specific account identifier may be included in a data field configured to store a primary account number. In one embodiment, the transaction message may be formatted based on one or more standards for the exchange of electronic transactions using payment cards.

In step 508, a specific account profile 210 stored in the account database 208 may be identified by a processing device (e.g., the processing unit 204) where the included account identifier corresponds to the specific account identifier included in the received transaction message. In step 510, an application transaction rule 214 stored in the rules database 212 may be identified by the processing device 204 based on a correspondence between the included one or more application criteria and data included in the one or more data fields included in the received transaction message. In step 512, the at least one required action included in the identified application transaction rule 214 may be performed by the processing device 204, wherein the at least one required action includes transmitting, by a transmitting device (e.g., the transmitting unit 206), financial education data to a consumer (e.g., the consumer 104) associated with the specific account profile using the included contact information.

In one embodiment, each account profile 210 may further include transaction data associated with a plurality of payment transactions involving the related transaction account. In a further embodiment, each application transaction rule 214 may be further identified based on a correspondence between the included one or more application criteria and the transaction data included in the identified specific account profile 210. In another further embodiment, the at least one required action may further include calculating, by the processing device 204, one or more values based on the transaction data included in the identified specific account profile 210, and the transmitted financial education data may further included the calculated one or more values.

In some embodiments, the method 500 may further include storing, in a services database (e.g., the services database 216), one or more service profiles (e.g., service profiles 218), wherein each service profile 218 includes data related to a financial service including at least service data. In a further embodiment, the at least one required action may further include identifying, by the processing device 204, at least one related service profile 218 in the services database 216 and the transmitted financial education data may further include service data included in the identified at least one related service profile 218. In an even further embodiment, each service profile may include one or more value algorithms, and identifying the at least one related service profile 218 may include calculating, by the processing device 204, one or more values associated with the related financial service using the included one or more value algorithms, where the transmitted financial education data further includes the calculated one or more values.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for providing financial education to consumers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for providing financial education services to a consumer, comprising:
storing, in an account database, a plurality of account profiles, wherein each account profile includes data related to a transaction account including at least an account identifier and contact information;
storing, in a rules database, one or more transaction rules, wherein each transaction rule is associated with a financial education opportunity and includes one or more application criteria and at least one required action;
receiving, by a receiving device, a transaction message associated with a payment transaction, wherein the transaction message is a copy of a transaction message used in the associated payment transaction and includes at least a specific account identifier and one or more data fields;
identifying, by a processing device, a specific account profile stored in the account database where the included account identifier corresponds to the specific account identifier included in the received transaction message;
identifying, by the processing device, an application transaction rule stored in the rules database based on a correspondence between the included one or more application criteria and data included in the one or more data fields included in the received transaction message;
performing, by the processing device, the at least one required action included in the identified application transaction rule, wherein
the at least one required action includes transmitting, by a transmitting device, financial education data to a consumer associated with the specific account profile using the included contact information.

2. The method of claim 1, wherein the one or more data fields include at least one of: a geographic location, a merchant identifier, a transaction amount, a merchant category, product data, offer data, loyalty data, and payment method.

3. The method of claim 1, wherein the specific account identifier is included in a data field configured to store a primary account number.

4. The method of claim 1, wherein each account profile further includes transaction data associated with a plurality of payment transactions involving the related transaction account.

5. The method of claim 4, wherein the application transaction rule is further identified based on a correspondence between the included one or more application criteria and the transaction data included in the identified specific account profile.

6. The method of claim 4, wherein
the at least one required action further includes calculating, by the processing device, one or more values based on the transaction data included in the identified specific account profile, and
the transmitted financial education data further includes the calculated one or more values.

7. The method of claim 1, further comprising:
storing, in a services database, one or more service profiles, wherein each service profile includes data related to a financial service including at least service data.

8. The method of claim 7, wherein
the at least one required action further includes identifying, by the processing device, at least one related service profile stored in the services database, and
the transmitted financial education data further includes service data included in the identified at least one related service profile.

9. The method of claim 8, wherein
each service profile further includes one or more value algorithms,
identifying the at least one related service profile includes calculating, by the processing device, one or more values associated with the related financial service using the included one or more value algorithms, and
the transmitted financial education data further includes the calculated one or more values.

10. The method of claim 1, wherein the transaction message is formatted based on one or more standards for the exchange of electronic transactions using payment cards.

11. A system for providing financial education services to a consumer, comprising:
a transmitting device;
an account database configured to store a plurality of account profiles, wherein each account profile includes data related to a transaction account including at least an account identifier and contact information;
a rules database configured to store one or more transaction rules, wherein each transaction rule is associated with a financial education opportunity and includes one or more application criteria and at least one required action;
a receiving device configured to receive a transaction message associated with a payment transaction, wherein the transaction message is a copy of a transaction message used in the associated payment transaction and includes at least a specific account identifier and one or more data fields; and
a processing device configured to
identify a specific account profile stored in the account database where the included account identifier corresponds to the specific account identifier included in the received transaction message,
identify an application transaction rule stored in the rules database based on a correspondence between the included one or more application criteria and data included in the one or more data fields included in the received transaction message, and
perform the at least one required action included in the identified application transaction rule, wherein
the at least one required action includes transmitting, by the transmitting device, financial education data to a consumer associated with the specific account profile using the included contact information.

12. The system of claim 11, wherein the one or more data fields include at least one of: a geographic location, a merchant identifier, a transaction amount, a merchant category, product data, offer data, loyalty data, and payment method.

13. The system of claim 11, wherein the specific account identifier is included in a data field configured to store a primary account number.

14. The system of claim 11, wherein each account profile further includes transaction data associated with a plurality of payment transactions involving the related transaction account.

15. The system of claim 14, wherein the application transaction rule is further identified based on a correspondence between the included one or more application criteria and the transaction data included in the identified specific account profile.

16. The system of claim 14, wherein
the at least one required action further includes calculating, by the processing device, one or more values based on the transaction data included in the identified specific account profile, and
the transmitted financial education data further includes the calculated one or more values.

17. The system of claim 11, further comprising:
a services database configured to store one or more service profiles, wherein each service profile includes data related to a financial service including at least service data.

18. The system of claim 17, wherein
the at least one required action further includes identifying, by the processing device, at least one related service profile stored in the services database, and
the transmitted financial education data further includes service data included in the identified at least one related service profile.

19. The system of claim 18, wherein
each service profile further includes one or more value algorithms,
identifying the at least one related service profile includes calculating, by the processing device, one or more values associated with the related financial service using the included one or more value algorithms, and
the transmitted financial education data further includes the calculated one or more values.

20. The system of claim 11, wherein the transaction message is formatted based on one or more standards for the exchange of electronic transactions using payment cards.
